(19) United States
(12) Patent Application Publication
(10) Pub. No.: US 2017/0341143 A1
(43) Pub. Date: Nov. 30, 2017

(54) METHOD FOR MANUFACTURING THREE-DIMENSIONAL SHAPED OBJECT

(71) Applicant: PANASONIC INTELLECTUAL PROPERTY MANAGEMENT CO., LTD., Osaka (JP)

(72) Inventors: Satoshi ABE, Osaka (JP); Isao FUWA, Osaka (JP); Masataka TAKENAMI, Aichi (JP); Mikio MORI, Osaka (JP)

(73) Assignee: PANASONIC INTELLECTUAL PROPERTY MANAGEMENT CO., LTD., Osaka (JP)

(21) Appl. No.: 15/538,442

(22) PCT Filed: Dec. 22, 2015
(86) PCT No.: PCT/JP2015/006401

§ 371 Date: Jun. 21, 2017

(30) Foreign Application Priority Data
Dec. 26, 2014 (JP) 2014-264798

(51) Int. Cl. B22F 3/105; B33Y 10/00; B29C 64/153; B29C 64/35; B33Y 40/00; B29K 105/00

(52) U.S. Cl. CPC B22F 3/1055; B29C 64/35; B33Y 40/00; B33Y 10/00; B29C 64/153; B22F 2003/1059; B29K 2105/251

(57) ABSTRACT

There is provided a manufacturing method of the three-dimensional shaped object, the method being capable of reducing an undesirable phenomenon associated with the contamination of the light transmission window with the fume substance. The manufacturing method according to an embodiment of the present invention is a method for manufacturing a three-dimensional shaped object by alternate repetition of a powder-layer forming and a solidified-layer forming, wherein the irradiation with light beam for the solidified-layer forming is performed by directing the light beam into the chamber through a light transmission window of the chamber, and wherein a gas blow is supplied to the light transmission window by use of a movable gas supply device, the light transmission window having been contaminated with a fume generated upon the formation of the solidified layer.

### TECHNICAL FIELD

The disclosure relates to a method for manufacturing a three-dimensional shaped object. More particularly, the disclosure relates to a method for manufacturing a three-dimensional shaped object, in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by newly forming a powder layer on the formed solidified layer, followed by similarly irradiating the powder layer with the light beam. See JP-T-01-502890 or JP-A-2000-73108, for example.

This kind of the manufacturing technology makes it possible to produce the three-dimensional shaped object with its complicated contour shape in a short period of time. The three-dimensional shaped object can be used as a metal mold in a case where inorganic powder material (e.g., metal powder material) is used as the powder material. While on the other hand, the three-dimensional shaped object can also be used as various kinds of models or replicas in a case where organic powder material (e.g., resin powder material) is used as the powder material.

Taking a case as an example wherein the metal powder is used as the powder material, and the three-dimensional shaped object produced therefrom is used as the metal mold, the selective laser sintering method will now be briefly described. As shown in FIGS. 7A-7C, a powder 19 is firstly transferred onto a base plate 21 by a movement of a squeegee blade 23, and thereby a powder layer 22 with its predetermined thickness is formed on the base plate 21 (see FIG. 7A). Then, a predetermined portion of the powder layer is irradiated with a light beam “L” to form a solidified layer 24 (see FIG. 7B). Another powder layer is newly provided on the solidified layer thus formed, and is irradiated again with the light beam to form another solidified layer. In this way, the powder-layer forming and the solidified-layer forming are alternately repeated, and thereby allowing the solidified layers 24 to be stacked with each other (see FIG. 7C). The alternate repetition of the powder-layer forming and the solidified-layer forming leads to a production of a three-dimensional shaped object with a plurality of the solidified layers integrally stacked therein. The lowermost solidified layer 24 can be provided in a state of adhering to the surface of the base plate 21. Therefore, there can be obtained an integration of the three-dimensional shaped object and the base plate. The integrated “three-dimensional shaped object” and “base plate” can be used as the metal mold as they are.

In general, the selective laser sintering method is carried out in a chamber 50 under some inert atmosphere so as to prevent an oxidation of the shaped object (see FIG. 8). As shown in FIG. 8, the chamber 50 is provided with a light transmission window 52, so that the irradiation with the light beam “L” is performed via the light transmission window 52. In other words, the light beam “L”, which is emitted from a light-beam irradiation means 3 provided outside the chamber 50, is directed into the chamber 50 through the light transmission window 52 thereof.

### PATENT DOCUMENTS (RELATED ART PATENT DOCUMENTS)

PATENT DOCUMENT 1: Japanese Unexamined Patent Application Publication No. H01-502890
PATENT DOCUMENT 2: Japanese Unexamined Patent Application Publication No. 2000-73108

### DISCLOSURE OF THE INVENTION

### Problems to be Solved by the Invention

Upon the formation of the solidified layer 24, a smoke-like material called “fume” (e.g., metal vapor or resin vapor) is generated from the irradiated portion with the light beam “L”. Specifically, as shown in FIG. 10, the fume 8 is generated from the irradiated portion with the light beam “L” at a point in time when the powder is subjected to the sintering or the melting and subsequent solidification by the irradiation of the light beam “L” via the light transmission window 52. The resulting fume moves upward within the chamber 50, causing the possibility of the light transmission window 52 being fogged with a substance attributable to the fume 8, the substance having adhered to the light transmission window 52. The substance which is attritubed to the fume will be hereinafter referred to as “fume substance”. The contamination of the light transmission window 52 with the fume causes variance in a transmittance or refractive index of the window 52 in terms of the light beam “L”. This can deteriorate an irradiation accuracy of the light beam “L” for the predetermined portion of the powder layer 22. Moreover, the contamination of the light transmission window 52 can bring about a scattering of the light beam “L” or a deterioration in the light condensing degree of the light beam “L”, which leads to an insufficient supply of the irradiation energy which is required for the powder layer.

Under these circumstances, the present invention has been created. That is, an object of the present invention is to provide a manufacturing method of the three-dimensional shaped object, the method being capable of reducing an undesirable phenomenon associated with the contamination of the light transmission window with the fume substance.

### Means for Solving the Problems

In order to achieve the above object, an embodiment of the present invention provides a method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by newly forming a powder layer on the formed solidified layer, followed by irradiation of a predetermined portion of the newly formed powder layer with the light beam,

wherein the powder-layer forming and the solidified-layer forming are performed within a chamber,

wherein the irradiation with light beam for the solidified-layer forming is performed by directing the light beam into the chamber through a light transmission window of the chamber, and

wherein a gas blow is supplied to the light transmission window by use Of a movable gas supply device, the light transmission window having been contaminated with a fume generated upon the formation of the solidified layer.

### Effect of the Invention

The use of the movable gas supply device according to an embodiment of the present invention can effectively perform a cleaning treatment for the light transmission window of the chamber. Thus, an embodiment of the present invention makes it possible to reduce the undesirable phenomenon associated with the contamination of the light transmission window with the fume substance in the manufacturing method of the three-dimensional shaped object.

### BRIEF DESCRIPTION OF THE DRAWINGS

FIG. 1A is a cross-sectional view schematically showing a general concept according to an embodiment of the present invention, the view being at a point in time before a gas blow is supplied to the light transmission window.

FIG. 1B is a cross-sectional view schematically showing a general concept according to an embodiment of the present invention, the view being at a point in time when a gas blow is being supplied to the light transmission window by use of a movable gas supply device.

FIG. 2A is a cross-sectional view schematically showing a first embodiment, the view being at a point in time before a gas blow is supplied to the light transmission window.

FIG. 2B is a cross-sectional view schematically showing a first embodiment, the view being at a point in time when a gas blow is being supplied to the light transmission window.

FIG. 3A is a cross-sectional view schematically showing a second embodiment, the view being at a point in time before a gas blow is supplied to the light transmission window.

FIG. 3B is a cross-sectional view schematically showing a second embodiment, the view being at a point in time when a gas blow is being supplied to the light transmission window.

FIG. 4A is a cross-sectional view schematically showing a third embodiment, the view being at a point in time before a gas blow is supplied to the light transmission window.

FIG. 4B is a cross-sectional view schematically showing a third embodiment, the view being at a point in time when a gas blow is being supplied to the light transmission window.

FIG. 5 is a perspective view schematically showing a fourth embodiment wherein a width dimension of a light-irradiated portion in an object is measured to give an understanding of a degree of contamination of a light transmission window.

FIG. 6 is a cross-sectional view schematically showing a fifth embodiment wherein a light transmissivity regarding a light beam is determined to give an understanding of a degree of contamination of a light transmission window.

FIG. 7 includes cross-sectional views schematically illustrating a laser-sintering/machining hybrid process for a selective laser sintering method wherein FIG. 7A shows a powder-layer forming, FIG. 7B shows a solidified-layer forming, and FIG. 7C shows a stacking of solidified layers.

FIG. 8 is a perspective view schematically illustrating a construction of a laser-sintering/machining hybrid machine.

FIG. 9 is a flow chart of general operations of a laser-sintering/machining hybrid machine.

FIG. 10 is a perspective view schematically showing a generation of fume.

### MODES FOR CARRYING OUT THE INVENTION

The present invention will be described in more detail with reference to the accompanying drawings. It should be noted that configurations/forms and dimensional proportions in the drawings are merely for illustrative purposes, and thus not the same as those of the actual parts or elements.

The term “powder layer” as used in this description and claims means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The term “fume” as used herein means a smoke-like material generated from the powder layer and/or the solidified layer upon being irradiated with the light beam during the manufacturing method of the three-dimensional shaped object. For example, the fume can correspond to “metal vapor attributed to the metal powder material” or “resin vapor attributed to the resin powder material”.

The directions of “upper” and “lower”, which are directly or indirectly used herein, are ones based on a positional relationship between a base plate and a three-dimensional shaped object. The side in which the manufactured three-dimensional shaped object is positioned with respect to the based plate is “upper”, and the opposite direction thereto is “lower”.

### [Selective Laser Sintering Method]

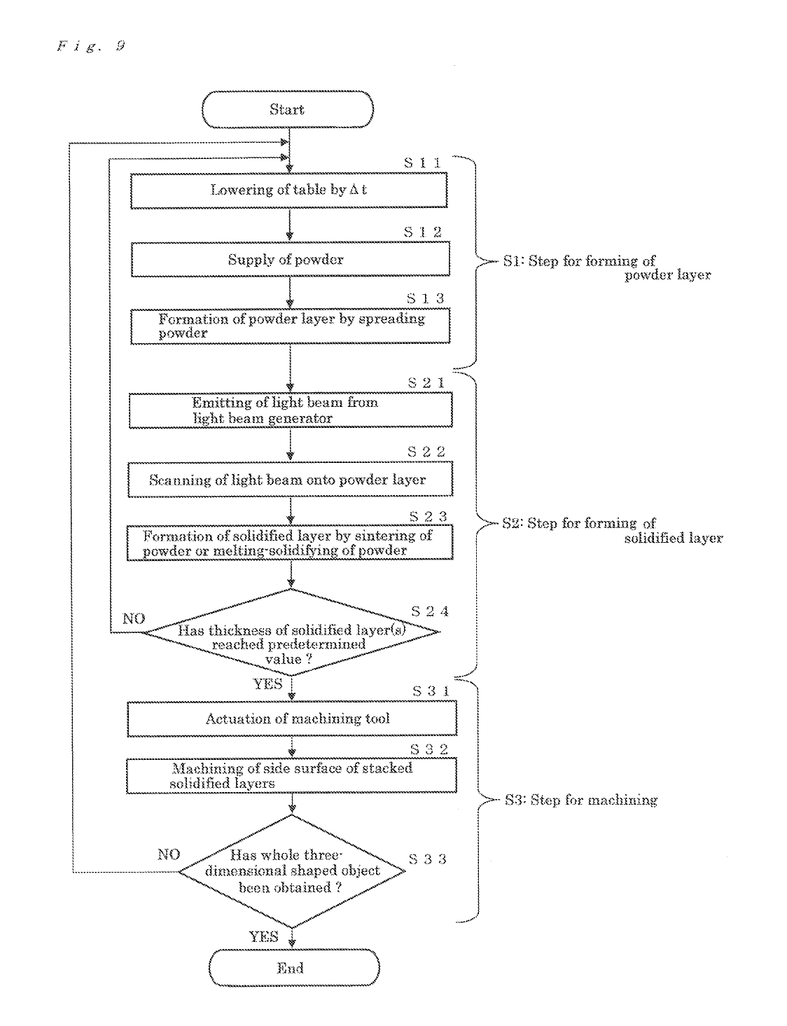

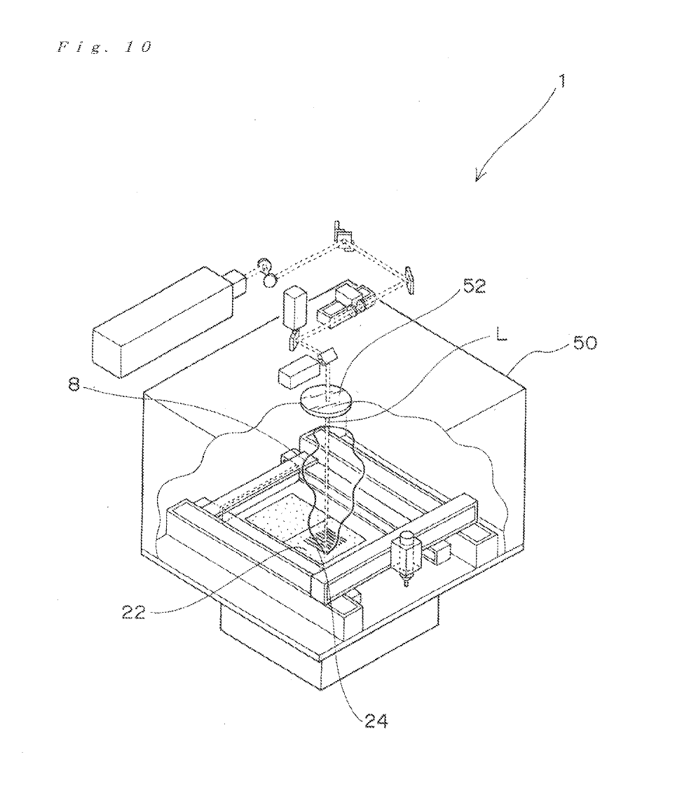

First of all, a selective laser sintering method, on which an embodiment of the manufacturing method of the present invention is based, will be described. By way of example, a laser-sintering/machining hybrid process wherein a machining is additionally carried out in the selective laser sintering method will be especially explained. FIGS. 7A-7C schematically show a process embodiment of the laser-sintering/machining hybrid. FIGS. 8 and 9 respectively show major constructions and operation flow regarding a metal laser sintering hybrid milling machine for enabling an execution of a machining process as well as the selective laser sintering method.

As shown in FIGS. 7A-7C and 8, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder). The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 7A-7C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a three-dimensional shaped object. The base plate is disposed on the forming table 20 and serves as a platform of the three-dimensional shaped object.

As shown in FIG. 8, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 8, the machining means 4 is mainly composed of a machining tool 40, a headstock 41 and an actuator 42. The machining tool 40 has a milling head for milling the side surface of the stacked solidified layers, i.e., the surface of the three-dimensional shaped object. The headstock 41, to which the machining tool 40 is attached to provide the machining means 4, is capable of moving horizontally and/or vertically. The actuator 42 is a driving means for the headstock 41, and thereby allowing the machining tool 40 attached to the headstock 41 to move toward the position to be machined.

Operations of the laser sintering hybrid milling machine 1 will now be described in detail. As can be seen from the flowchart of FIG. 9, the operations of the laser sintering hybrid milling machine 1 are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 7A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 7B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 7C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The headstock 41 is actuated, and thereby the machining tool 40 attached to such headstock 41 is actuated in order to initiate an execution of the machining step (S31). For example, in a case where the machining tool 40 has an effective milling length of 3 mm, a machining can be performed with a milling depth of 3 mm. Therefore, supposing that “Δt” is 0.05 mm, the machining tool 40 is actuated when the formation of the sixty solidified layers 24 is completed. Specifically, the side face of the stacked solidified layers 24 is subjected to the surface machining (S32) through a movement of the machining tool 40 driven by the actuator 42. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### [Manufacturing Method of the Present Invention]

An embodiment of the present invention is characterized by a treatment which is additionally performed in association with the formation of the solidified layer. Specifically, the manufacturing method according to an embodiment of the present invention makes a treatment for a light transmission window which has been contaminated with “fume” generated upon the formation of the solidified layer. This treatment corresponds to an after-countermeasure for treating the light transmission window which has been once contaminated with the fume, not a preventive countermeasure for preventing the light transmission window from being contaminated with the fume.

Upon the formation of the solidified layer 24 is performed by the irradiation of the powder layer 22 with the light beam “L” through the light transmission window 52 of the chamber 50, there is a fume 8 generated from the irradiated portion with the light beam “L” (see FIG. 8). The fume 8 has a smoke-like form, and thus tends to move upward within the chamber 50, as shown in FIG. 8. As a result, the substance of the fume (i.e., “fume substance”) adheres onto the light transmission window 52 of the chamber 50, which causes the contamination of the light transmission window 52 therewith. Specifically, the light transmission window 52 becomes fogged due to the presence of the fume substance. The inventors of the present application have found that the contamination of the light transmission window 52 of the chamber 50 can cause the undesired problem for the formation of the solidified layer. In particular, the inventors have found that the contamination of the light transmission window 52 with the fume substance causes variance in a transmittance or refractive index regarding the light beam “L”, which will lead to a deterioration in an irradiation accuracy of the light beam “L” with respect to the predetermined portion of the powder layer 22. They have also found that the contamination of the light transmission window 52 can bring about a scattering of the light beam “L” and/or a deterioration in the light condensing degree of the light beam “L” at the irradiated portion, which will lead to an insufficient supply of the irradiation energy required for the powder layer 22. The deteriorated irradiation accuracy of the light beam “L” and the insufficient supply of the irradiation energy for the predetermined portion of the powder layer 22 make it impossible for the solidified layer 24 to have a desired solidified density. This means there is a possibility that the strength of the three-dimensional shaped object will be disadvantageously reduced.

The inventors of the present application conducted an intensive study on the manufacturing method of the three-dimensional shaped object so as to reduce the undesired phenomenon associated with the light transmission window. As a result, they have finally created the present invention which is featured by the use of a movable gas supply device. In this regard, an embodiment of the present invention makes use of the movable gas supply device to supply a gas blow onto the light transmission window which has been contaminated with the fume generated upon the formation of the solidified layer.

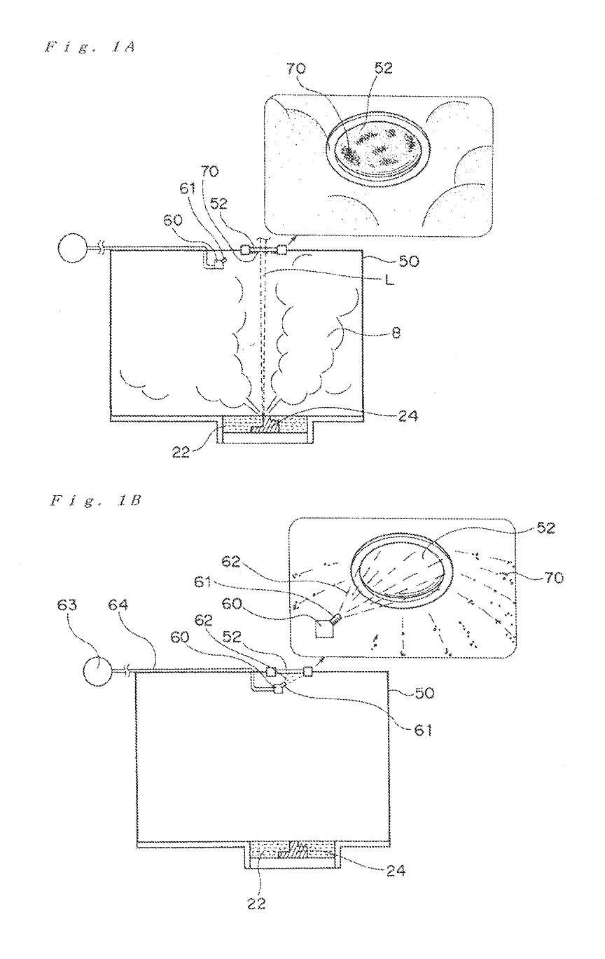

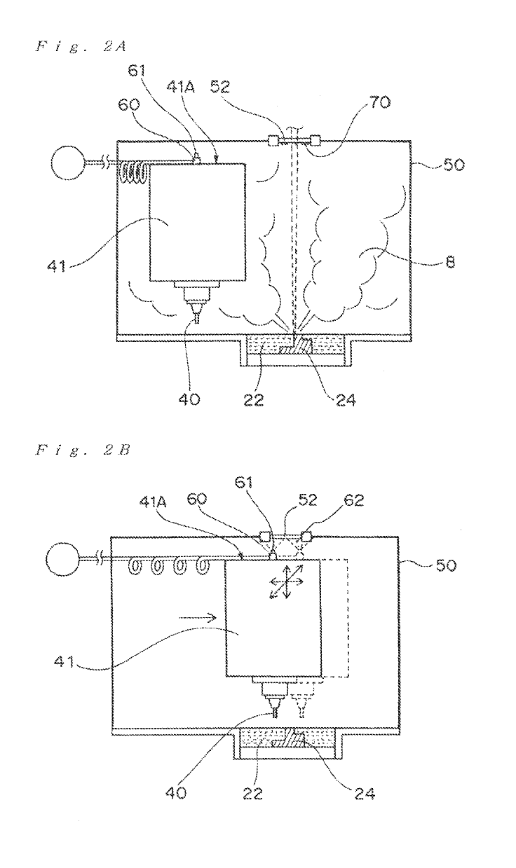

Referring to FIGS. 1A and 1B, the technical concept according to an embodiment of the present invention will now be described. FIG. 1A shows the view at a point in time before a gas blow is supplied. Specifically, FIG. 1A shows the view wherein the fume 8 is generated upon the formation of the solidified layer, and thereby the light transmission window 52 becomes contaminated with the fume substance 70. While on the other hand, FIG. 1B shows the view at a point in time when a gas blow is being supplied. Specifically, FIG. 1B shows the view wherein the gas 62 is being sprayed with respect to the light transmission window 52 by use of the movable gas supply device 60, the window 52 having been contaminated with the fume substance 70.

As shown in FIG. 1A, the chamber 50, in which the formations of the powder layer 22 and the solidified layer 24 are performed, is provided with the light transmission window 52. As can be seen from FIG. 1A, the light transmission window 52 is positioned in the upper wall of the chamber 50, for example. The light transmission window 52 itself is made of a transparent material, allowing the light beam “L” to enter the interior of the chamber 50 from the outside thereof. Upon the irradiation of the powder layer 22 with the light beam “L” via the light transmission window 52, the fume 8 is generated from the irradiated portion with the light beam “L”. The generated fume 8 moves upward within the chamber 50. The fume 8 includes the fume substance 70 made of a metal or resin component attributed to the powder layer and/or solidified layer. Thus, the contamination of the light transmission window 52 is caused by the fact that the fume substance 70 adheres to the light transmission window 52 of the chamber 50 (see partially enlarged perspective view in FIG. 1A).

According to an embodiment of the present invention, the gas supply device 60 is moved to be positioned adjacent to the light transmission window 52 so that the gas 62 is sprayed from the gas supply device 60 toward the light transmission window 52. By way of example, the movable gas supply device 60 is moved to be positioned below the light transmission window 52, and thereby the blow of the gas 62 is upwardly supplied from the gas supply device 60, as shown in FIG. 1B.

The gas supply device 60 according to an embodiment of the present invention is movable, allowing the device to move to a suitable position for the blow of the gas 62 with respect to the light transmission window 52. This makes it possible for the gas supply device 60 to be suitably positioned at a region below the light transmission window 52 or an adjacent region thereto, which leads to an effective cleaning treatment for the light transmission window 52. Such cleaning treatment can serve to effectively remove the fume substance 70 from the light transmission window 52.

According to an embodiment of the present invention, the effective cleaning of the light transmission window 52 can be achieved, making it possible to prevent the lowered transmittance or refractive index of the light beam “L” at the time of the manufacturing of the three-dimensional shaped object. This can lead to a prevention of the lowered accuracy of the irradiation of the light beam “L” with respect to the predetermined portion of the powder layer 22. Further, such effective cleaning can prevent a scattering of the light beam “L” in the light transmission window 52 and/or a deterioration in the light condensing degree of the light beam “L” at the irradiated portion. This can avoid the insufficient supply of the irradiation energy which is required for the predetermined portion of the powder layer 22. As a result, the solidified layer becomes to have a desired solidified density, and thereby there can be finally obtained a three-dimensional shaped object with the desired strength.

According to one preferred embodiment of the present invention, the gas supply device 60 is moved to be positioned below the light transmission window 52, and the blow of the gas 60 is upwardly supplied from the positioned gas supply device 60 (see FIGS. 1A and 1B). The phrase “gas blow is upwardly supplied” as used herein substantially means that the gas 62 is supplied from the gas supply device 60 under such a condition that a gas supplying port 61 is oriented upward. Typically, the gas blow is supplied from the gas supply device 60 to the light transmission window 52 under such a condition that the gas supplying port 61 has a vertically upward orientation. It should be noted that there is no need for the gas supplying port 61 to necessarily have the vertically upward orientation. The supply of the gas 60 can be performed under such a condition that the orientation of the gas supplying port 61 is offset/different from the vertically upward in the range of ±45°, preferably from the vertically upward in the range of ±35°, more preferably from the vertically upward in the range of ±30°.

For example in a case where there is non-uniformity on the amount of the fume substance 70 adhered on the light transmission window 52, it is possible for the gas supply device 60 to move to be located close to the region where the more amount of the adhered fume substance is present. This allows the blow of the gas 62 to be concentrated onto the more amount of the adhered fume substance 70, which leads to an effective cleaning of the light transmission window. In other words, an embodiment of the present invention can conduct the cleaning treatment of the light transmission window 52, depending on the adhered amount of the fume substance 70.

The term “movable gas supply device” as used herein substantially means a device for supplying a gas blow to the light transmission window, the device being capable of moving in the horizontal direction and/or vertical direction as a whole. The gas supply device itself is equipped with a drive mechanism for the movement of the device. Alternatively, the gas supply device can be not equipped with the drive mechanism for the movement thereof, and instead may be mounted on a separate moving means having its drive mechanism for the movement. Moreover, term “movable gas supply device” as used herein includes an embodiment wherein a gas supplying port of the gas supply device is rotatable so that the port oscillates.

The timing of supplying the gas blow according to an embodiment of the present invention is preferably at a point in time when no irradiation with the light beam is performed. That is, it is preferred that, at a point in time during no irradiation with the light beam “L”, the blow of the gas 62 is supplied to the light transmission window 52 by use of the gas supply device 60. More specifically, it is preferred that the blow of the gas 62 is supplied from the gas supply device 60 onto the light transmission window 52 when the irradiation of the powder layer 22 with the light beam “L” is not performed. The reason for this is that the fume 8 generated upon the irradiation with the light beam “L” may be entrained by the blow of the gas 62 (the blow being supplied from the gas supply device 60 to the light transmission window 52), and thereby the fume 8 can be disadvantageously conveyed onto the light transmission window 52.

According to one preferred embodiment of the present invention, the fume may be discharged to the outside of the chamber by a ventilating means of the chamber, in which case the gas blow may be supplied under the condition of the stop or intermission of the light beam irradiation. This makes it possible to supply the gas blow to the light transmission window, while greatly suppressing the influence of the generated fume.

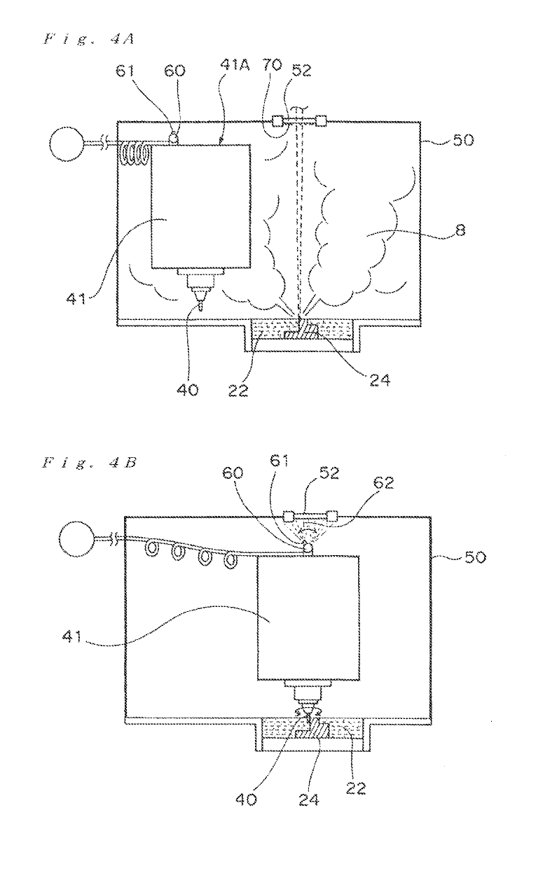

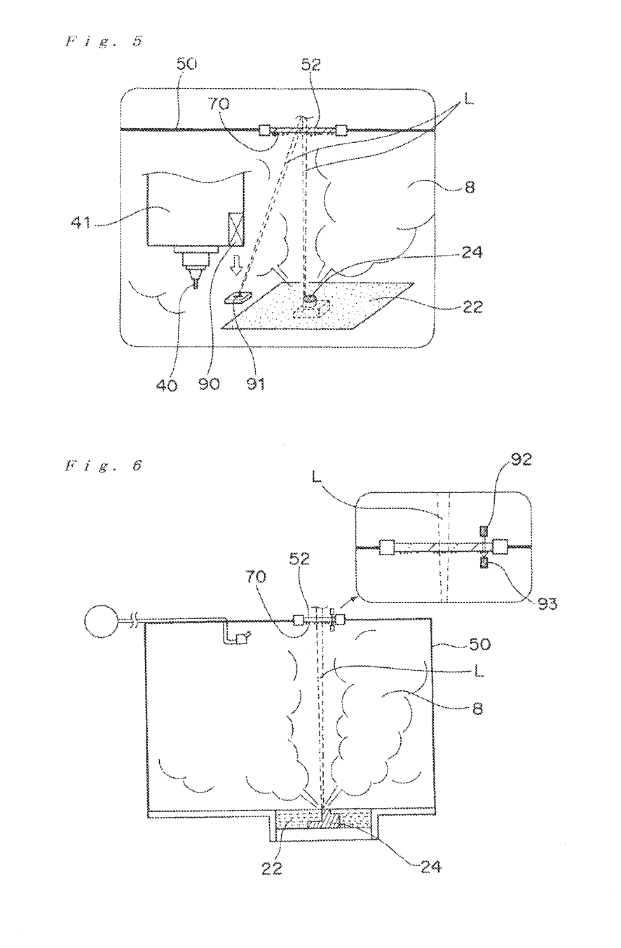

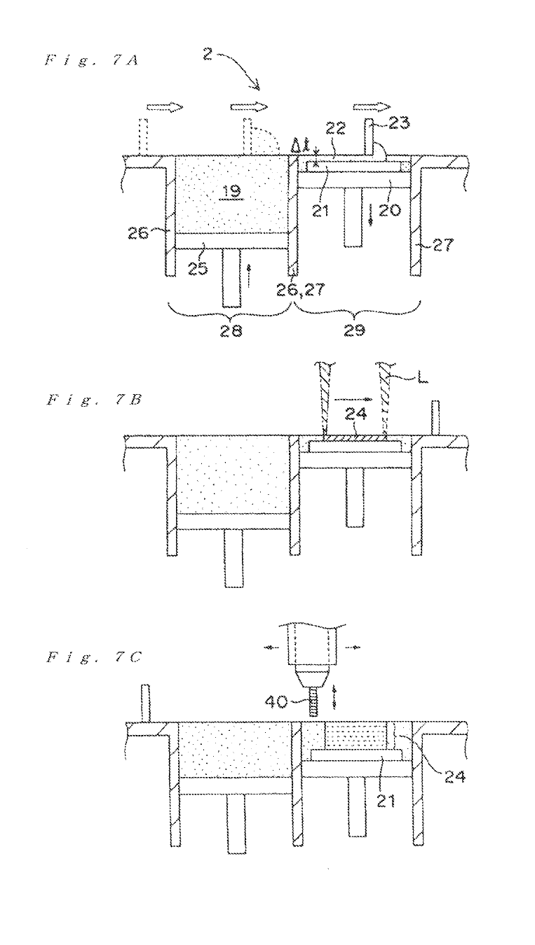

The gas blow at the time of no irradiation of the light beam may be performed in conjunction with the machining of the solidified layer 24, which will be described below in more detail. That is, the gas 62 may be sprayed onto the light transmission window 52 at the time of the machining process (see FIG. 4B). This makes it possible to reduce the manufacturing time of the three-dimensional shaped object as a whole, which will lead to an effective manufacturing of the shaped object.

As shown in FIG. 1B, the gas supply device 60 is preferably connected with a source 63 of the gas supply. For example, the gas supply device 60 and the source 63 of the gas supply are connected with each other via a connecting line 64. The source 63 of the gas supply may be configured to have a gas pump for example, so that a pressure necessary for the gas blow is provided. It is also preferred that the connecting line 64 has a flexible form (e.g., accordion structure) to facilitate the movability of the gas supply device 60. Examples of the kind of the gas supply device 60 include, but not limited to, a nozzle-type device and slit-type device. That is, the gas supplying port 61 of the gas supply device 60 may have a form of nozzle or slit.

The kind of the gas 62 of the blow from the gas supply device 60 to the light transmission window 52 may be the same as that of atmosphere gas of the interior of the chamber. Such gas may be at least one kind selected from the group consisting of nitrogen, argon and air, for example.

The blow of the gas 62 may be continuously supplied with respect to the light transmission window 52. Alternatively, the blow of the gas 62 may also be discontinuously supplied with respect to the light transmission window 52. In this regard, it is preferred that the blow of the gas 62 from the gas supply device 60 is supplied in a pulsed manner. This means that the pulsed blow of the gas 62 is preferably supplied from the gas supply device 60 toward the light transmission window 52. The pulsed manner makes it possible to apply a vibration force to the light transmission window 52 upon the blow of the gas 62, which leads to an effective removal of the fume substance 70. That is, even in a case where the amount of the fume substance 70 adhered onto the light transmission window 52 is large, or even in another case where the adhering strength of the fume substance is high, the fume substance 70 can be effectively removed from the light transmission window 52.

The manufacturing method of the present invention can be variously embodied, which will be hereinafter described.

### First Embodiment

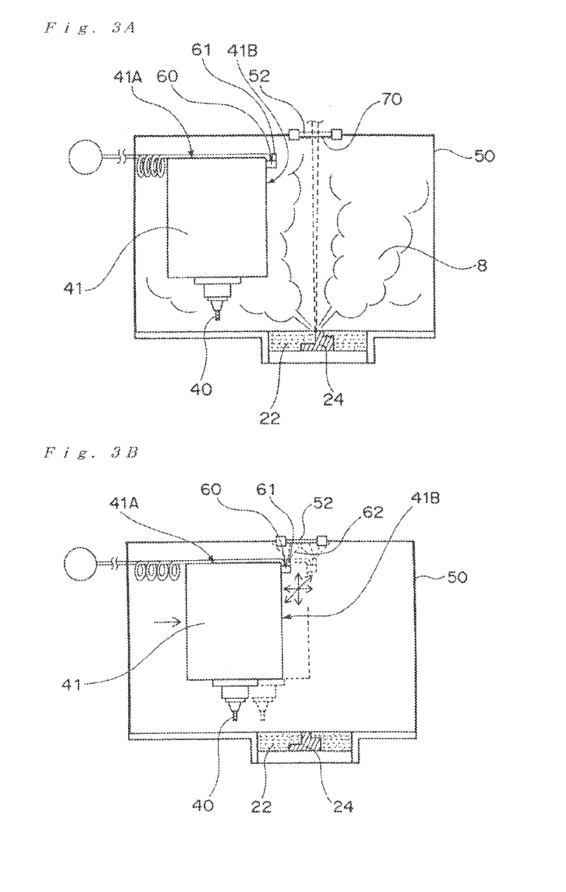

According to the first embodiment of the present invention, the gas blow is performed by use of the gas supply device 60 equipped with a machining means (FIGS. 2A and 2B).

More specifically, in the manufacturing of the three-dimensional shaped object wherein the solidified layer 24 is subjected to an at least one machining by a machining means 4 which comprises a headstock 41 provided with a machining tool 40 (see FIGS. 2A and 8), the movable gas supply device 60 is one attached onto the headstock 41 of the machining means 4.

As shown in FIGS. 2A and 2B, the gas supply device 60 is in a mounted state on the upper surface 41A of the headstock 41 which is located within the chamber 50. The headstock 41, which is equipped with the machining tool 40 for machining the side surface of the solidified layers 24, is capable of moving horizontally and/or vertically within the chamber 50. Due to the gas supply device 60 mounted on the upper surface 41A of the headstock 41 capable of moving within the chamber 50, the movability of the gas supply device 60 is provided.

By moving the headstock 41 until it reaches the region below the light transmission window 52, the gas supply device 60 is moved to be positioned below the light transmission window 52, in which case the blow of the gas 62 is upwardly supplied from the gas supply device 60 to the light transmission window 52. It should be noted that the headstock 41 is provided within the chamber 50 for the original purpose of the machining of the solidified layer. Thus, the use of the headstock 41 for the movability of the gas supply device can contribute to the effective utilization of the manufacturing apparatus.

The more detailed matters on the first embodiment will now be described. As shown in FIG. 2A, the headstock 41 is in a resting state during the irradiation of the predetermined portion of the powder layer 22 with the light beam “L”. The resting state of the headstock 41 means the resting of the gas supply device 60 located on the upper surface 41A of the headstock 41. While on the other hand, as shown in FIG. 2B, the headstock 41 is forced to move from the static position in order to perform the machining of the solidified layer 24. That is, the machining for the predetermined portion of the side surface of the solidified layer 24 is performed by the horizontal and/or vertical movement of the headstock 41. As such, the movability of the headstock 41 is utilized to move the gas supply device 60 located thereon. For example, when the headstock 41 is moved to located below the light transmission window 52 as shown in FIG. 2B, then the gas supply device 60 located on the headstock 41 can also become positioned below the light transmission window 52, and thereby the upward blow of the gas 62 from the gas supply device 60 can be supplied.

The blow of the gas 62 may be performed while the gas supply device 60 is being moved. That is, the blow of the gas 62 is supplied from the gas supply device 60 to the light transmission window 52, while the headstock 41 is being moved. More specifically, the blow of the gas 62 toward the light transmission window 52 may be performed during the continuous movement of the headstock 41 such that the gas supply device 60 undergoes a reciprocating motion horizontally and/or vertically. This can serve to more effectively remove the fume substance 70. That is, even in a case where the amount of the fume substance 70 adhered onto the light transmission window 52 is large, or even in another case where the adhering strength of the fume substance is high, the fume substance 70 can be effectively removed from the light transmission window 52.

In the first embodiment of the present invention, the blow of the gas 62 and the machining of the solidified layer 24 may be performed in parallel with each other. The headstock 41 is subjected to a movement upon the machining of the solidified layer 24, in which case the movement of the headstock 41 for the machining may be positively utilized as the movement of the gas supply device 60. More specifically, the blow of the gas 62 toward the light transmission window 52 may be supplied from the gas supply device 60 while the device is undergoing a continuous motion which is attributed to the movement of the headstock 41 at the time of machining.

### Second Embodiment

Similarly to the above embodiment, the second embodiment of the present invention performs the gas blow by use of the gas supply device equipped with a machining means (FIGS. 3A and 3B). The second embodiment of the present invention can correspond to the modification of the first embodiment. As shown in FIGS. 3A and 3B, the gas supply device 60 according to the second embodiment is mounted on the side surface 41B of the headstock 41 which is located within the chamber 50.

According to the second embodiment of the present invention, the gas supply device 60 can be disposed on the headstock 41 even in a case where a space between the upper surface 41A of the headstock 41 and the upper wall of the chamber 50 is small.

The gas supply device 60 is in a mounted state on the side surface 41B of the headstock 41 capable of moving horizontally and/or vertically within the chamber 50, and thereby the movability of the gas supply device 60 is provided. For example, the moving of the headstock 41 makes it possible for the gas supply device 60 mounted on the headstock 41 to be positioned below the light transmission window 52 (see FIG. 3B), in which case the blow of the gas 62 can be upwardly supplied from the gas supply device 60. Similarly to the first embodiment, the blow of the gas 62 toward the light transmission window 52 may be performed during the movement of the headstock 41 so that the gas supply device 60 undergoes a reciprocating motion horizontally and/or vertically.

As shown in FIGS. 2A, 2B, 3A and 3B, the gas supplying port 61 of the gas supply device 60 located on the upper surface 41A or side surface 41B of the headstock 41 has a fixed orientation in the first or second embodiment. Even in the case of the fixed orientation of the gas supplying port 61, the various directions of the gas blow can be achieved by the movement of the headstock 41 so that the gas supply device 60 moves horizontally and/or vertically.

### Third Embodiment

The third embodiment of the present invention performs the gas blow by use of the gas supply device which is capable of changing the orientation of the gas supplying port (see FIGS. 4A and 4B).

According to the third embodiment of the present invention, the blow of the gas 62 is supplied to the light transmission window 52, while the orientation of the gas supplying port 61 of the gas supply device 60 is being continuously changed.

On the upper surface 41A of the headstock 41 located within the chamber 50, the gas supply device 60 capable of suitably changing the orientation of the gas supplying port 61 is mounted (see FIGS. 4A and 4B). As shown in FIG. 4A, the headstock 41 is in a resting state during the irradiation of the predetermined portion of the powder layer 22 with the light beam “L”. The resting state of the headstock 41 means the resting of the gas supply device 60 located on the upper surface 41A of the headstock 41. When the headstock 41 is moved to located below the light transmission window 52 as shown in FIG. 4B, then the gas supply device 60 located on the headstock 41 can also become positioned below the light transmission window 52, and thereby the upward blow of the gas 62 from the gas supply device 60 can be provided.

In particular, the gas supplying port 61 of the gas supply device 60 according to the third embodiment has a changeable orientation. Thus, as shown in FIG. 4B, the blow of the gas 62 is supplied to the light transmission window 52, while the orientation of the gas supplying port 61 is being continuously changed. In other words, the blow of the gas 62 is supplied from the gas supply device 60 to the light transmission window 52 while subjecting the gas supplying port 61 to a reciprocating motion so that the port 61 oscillates.

With no need for the moving of the headstock 41, the third embodiment can widely apply the gas blow to the light transmission window 52 through the continuous changing of the orientation of the gas supplying port 61. This can lead to an effective cleaning treatment for the light transmission window 52.

### Fourth Embodiment

The present invention according to the fourth embodiment gains an understanding of the degree of the contamination of the light transmission window 52 by measuring the width dimension of the irradiated portion of the object 91 with the light beam “L” (see FIG. 5).

According to the fourth embodiment, the “object to be irradiated” 91 is placed within the chamber 50, and then the object 91 is irradiated with the light beam “L” through the light transmission window 52 to serially measure a width dimension of the irradiated portion of the object, and thereby giving an understanding of the degree of the contamination of the light transmission window 52.

The more detailed matters on the fourth embodiment will now be described. As shown in FIG. 5, the “object to be irradiated” 91 is disposed in the interior of the chamber 50, and thereafter the object 91 is irradiated with the light beam “L” through the light transmission window 52. The term “object to be irradiated” (91) means an object used for the understanding of the contamination degree of the light transmission window 52, the object being capable of undergoing its color change by the irradiation thereof with the light beam “L”. As shown in FIG. 5, the irradiated portion with the light beam “L” can be tinged with different color from that of non-irradiation in the object 91. In a case of the fume substance 70 adhered onto the light transmission window 52, the light beam “L”, which has been directed into the chamber 50 through the light transmission window 52, can scatter due to the presence of the adhered fume substance 70. Thus, when the object 91 is irradiated with the light beam “L” under the presence of the fume substance 70 adhered on the light transmission window 52, the width dimension of the irradiated portion with the light beam “L” becomes larger, compared with that of non-scatter of the light beam. The reason for this is that the scattering of the light beam “L” makes the irradiation area wider. As such, the embodiment of the present invention serially measures the width dimension by use of an imaging device (e.g., CCD camera 90) to gain an understanding of how much the light transmission window 52 is contaminated (i.e., the understanding of the degree of the contamination of the light transmission window 52) on the basis of the measured width dimension. It is preferred that the width dimension of the irradiated portion of the object 91 with the light beam “L” is preliminarily measured under no presence of the fume substance 70 adhered on the light transmission window 52. This can contribute to the more suitable understanding of the degree of the contamination through the comparison with the preliminarily measured width dimension. The imaging device such as the CCD camera 90 and the like may be mounted on the lower part or side part of the headstock 41, as shown in FIG. 5.

When it is judged that the cleaning is needed on the basis of the contamination degree of the light transmission window 52, then the gas blow is supplied from the gas supply device 60 to the light transmission window 52 to remove the adhered fume substance 70 of the light transmission window 52.

### Fifth Embodiment

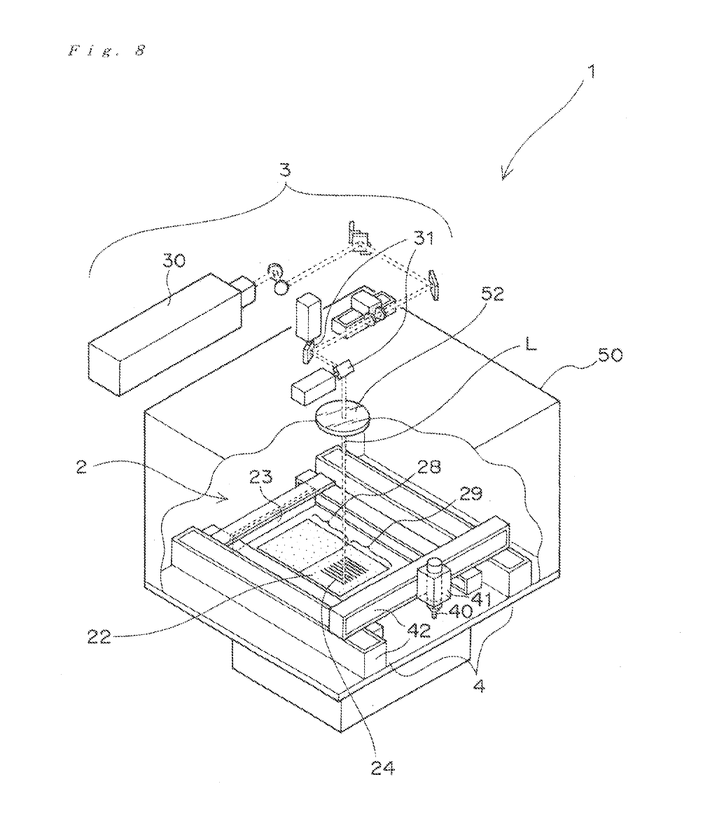

The present invention according to the fifth embodiment gains an understanding of the degree of the contamination of the light transmission window 52, based on a light transmissivity (see FIG. 6).

According to the fifth embodiment, the degree of the contamination of the light transmission window 52 can be provided by receiving the light which has passed through the light transmission window 52, followed by serially determining the light transmissivity of the light transmission window 52.

The more detailed matters on the fifth embodiment will now be described. As shown in FIG. 6, the light transmissivity of the light transmission window 52 is serially determined by use of an optical emitter 92 and an optical receiver 93 which are located in opposed positions via the light transmission window 52, and thereby giving an understanding of a degree of the contamination of the light transmission window 52. That is, the optical emitter 92 and the optical receiver 93 are used to determine the light transmissivity of the light transmission window 52 with time, which gives the understanding of the contamination degree of the light transmission window 52. The optical emitter 92, which is located outside the chamber 50, is a device for emitting a light toward the light transmission window 52. While on the other hand, the optical receiver 93, which is located inside the chamber 50, is a device for receiving the light which has emitted from the optical emitter 92 and then passed through the light transmission window 52. The specific examples of the optical emitter 92 and the optical receiver 93 are not limited to particular ones, but may be conventional ones as a light-emitting means and a light-receiving means, respectively. It is preferred that the light transmissivity is preliminarily determined under no presence of the fume substance 70 adhered on the light transmission window 52 in order to gain the understanding of the degree of the contamination through the comparison with the preliminarily determined transmissivity. When the transmissivity is lower than the preliminarily determined one, it is indicated that the fume substance 70 has been adhered onto the light transmission window 52, and thus the light transmission window 52 becomes contaminated. As such, the contamination degree of the light transmission window 52 can be understood by the value of the lowered transmissivity.

When it is judged that the cleaning is needed on the basis of the contamination degree of the light transmission window 52, the gas blow is supplied from the gas supply device 60 to the light transmission window 52 to remove the adhered fume substance 70 of the light transmission window 52.

Although several embodiments of the present invention have been hereinbefore described, the present invention is not limited to these embodiments. It will be readily appreciated by those skilled in the art that various modifications are possible without departing from the scope of the present invention.

For example, although the supply of the gas blow to the light transmission window is performed on the basis of the understanding of the contamination degree of the light transmission window according to the fourth and fifth embodiments, the present invention is not limited to that. Another embodiment of the present invention is possible wherein the gas blow is performed periodically. In this regard, each time the given time passes, the gas blow for the light transmission window may be performed by the movable gas supply device.

It should be noted that the present invention as described above includes the following aspects:
The first aspect: A method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by newly forming a powder layer on the formed solidified layer, followed by irradiation of a predetermined portion of the newly formed powder layer with the light beam,

wherein the powder-layer forming and the solidified-layer forming are performed within a chamber,

wherein the irradiation with light beam for the solidified-layer forming is performed by directing the light beam into the chamber through a light transmission window of the chamber, and

wherein a gas blow is supplied to the light transmission window by use of a movable gas supply device, the light transmission window having been contaminated with a fume generated upon the formation of the solidified layer.
The second aspect: The method according to the first aspect, wherein the movable gas supply device is moved to be positioned below the light transmission window, and thereby the gas blow is upwardly supplied from the gas supply device.
The third aspect: The method according to the first or second aspect, wherein the solidified layer is subjected to an at least one machining by a machining means which comprises a headstock provided with a machining tool, and

wherein the movable gas supply device is one attached onto the headstock of the machining means.
The fourth aspect: The method according to the third aspect, wherein the gas blow is supplied from the gas supply device to the light transmission window, while the headstock is being moved.
The fifth aspect: The method according to the third or fourth aspect, wherein the gas blow is supplied to the light transmission window in conjunction with the machining of the solidified layer.
The sixth aspect: The method according to any one of the first to fifth aspects, wherein the gas blow is supplied to the light transmission window, while an orientation of a gas supplying port of the gas supply device is being continuously changed.
The seventh aspect: The method according to any one of the first to sixth aspects, wherein, at a point in time during no irradiation with the light beam, the gas blow is supplied to the light transmission window by use of the gas supply device.
The eighth aspect: The method according to any one of the first to seventh aspects, wherein an object to be irradiated is placed within the chamber, and

the object is irradiated with the light beam through the light transmission window to serially measure a width dimension of the irradiated portion of the object, and thereby giving an understanding of a degree of the contamination of the light transmission window.
The ninth aspect: The method according to any one of the first to seventh aspects, wherein a light transmissivity of the light transmission window is serially determined by use of an optical emitter and an optical receiver which are located in opposed positions via the light transmission window, and thereby giving an understanding of a degree of the contamination of the light transmission window.
The tenth aspect: The method according to any one of the first to ninth aspects, wherein the gas blow from the gas supply device toward the light transmission window is supplied in a pulsed manner.

### INDUSTRIAL APPLICABILITY

The manufacturing method according to an embodiment of the present invention can provide various kinds of articles. For example, in a case where the powder layer is a metal powder layer (i.e., inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., organic powder layer) and thus the solidified layer corresponds to a cured layer, the three-dimensional shaped object obtained by an embodiment of the present invention can be used as a resin molded article.

### CROSS REFERENCE TO RELATED PATENT APPLICATION

The present application claims the right of priority of Japanese Patent Application No. 2014-264798 (filed on Dec. 26, 2014, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

4 Machining tool
8 Fume
22 Powder layer
24 Solidified layer
40 Machining tool
41 Headstock
50 Chamber
51 Light transmission window
60 Gas supply device
61 Gas supplying port
62 Gas
91 Object to be irradiated
L Light beam

1. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by newly forming a powder layer on the formed solidified layer, followed by irradiation of a predetermined portion of the newly formed powder layer with the light beam,
wherein the powder-layer forming and the solidified-layer forming are performed within a chamber,
wherein the irradiation with light beam for the solidified-layer forming is performed by directing the light beam into the chamber through a light transmission window of the chamber,
wherein a gas blow is supplied to the light transmission window by use of a movable gas supply device, the light transmission window having been contaminated with a fume generated upon the formation of the solidified layer,
wherein the solidified layer is subjected to an at least one machining by a machining means which comprises a headstock provided with a machining tool, and
wherein the movable gas supply device is one attached onto the headstock of the machining means.

2. The method according to claim 1, wherein the movable gas supply device is moved to be positioned below the light transmission window, and thereby the gas blow is upwardly supplied from the gas supply device.

3. (canceled)

4. The method according to claim 1, wherein the gas blow is supplied from the gas supply device to the light transmission window, while the headstock is being moved.

5. The method according to claim 1, wherein the gas blow is supplied to the light transmission window in conjunction with the machining of the solidified layer.

6. The method according to claim 1, wherein the gas blow is supplied to the light transmission window, while an orientation of a gas supplying port of the gas supply device is being continuously changed.

7. The method according to claim 1, wherein, at a point in time during no irradiation with the light beam, the gas blow is supplied to the light transmission window by use of the gas supply device.

8. The method according to claim 1, wherein an object to be irradiated is placed within the chamber, and
the object is irradiated with the light beam through the light transmission window to serially measure a width dimension of the irradiated portion of the object, and thereby giving an understanding of a degree of the contamination of the light transmission window.

9. The method according to claim 1, wherein a light transmissivity of the light transmission window is serially determined by use of an optical emitter and an optical receiver which are located in opposed positions via the light transmission window, and thereby giving an understanding of a degree of the contamination of the light transmission window.

10. The method according to claim 1, wherein the gas blow from the gas supply device toward the light transmission window is supplied in a pulsed manner.
